(19) United States
(12) Patent Application Publication
(10) Pub. No.: US 2006/0085475 A1
(43) Pub. Date: Apr. 20, 2006

(54) Method and apparatus for managing and providing vehicle information

(76) Inventors: John Colagross, Muscle Shoals, AL (US); Jim Jackson, Florence, AL (US)

Correspondence Address: WADDEY & PATTERSON, 1600 DIVISION STREET, SUITE 500, NASHVILLE, TN, 37203, US

(21) Appl. No.: 10/659,404

(22) Filed: Sep. 10, 2003

(51) Int. Cl. G06F 17/00; G06F 7/00

(52) U.S. Cl. 707/104.1

(57) ABSTRACT

An efficient method for management of the information pertaining to the function and operation of vehicle features of the selected vehicles is disclosed. Individual digitized audio recording of spoken information pertaining to the function and operation of individual features of the selected grouping of vehicles are made and stored as individual data files in a common vehicle information database. Information pertaining to the identification of a particular vehicle is input as a sorting index for sorting through and selecting out selected individual data files which, together, contain the information pertaining to the function and operation of such selected features as corresponds to the selected vehicle. That information is then recorded onto an audio media storage device as audio tracks and provided to the customer for use with an audio media player.

### BACKGROUND

The present invention relates to a method and a system for providing vehicle information pertaining to the function and operation of features of a selected vehicle to a user. More specifically, the present invention relates to a system that provides to a user an audio-media storage device having recordings of selected vehicle information pertaining to the function and operation of features of a selected vehicle.

The modern automobile customer is faced with a daunting array of choices for not only car models from which to choose, but also with respect to the array of choices of options and features for each car model. The average size of automobile dealerships for both new and used vehicles is growing. With increasing frequency, dealerships sell multiple automobile lines at more than one location. Moreover, even within an automobile type, or manufacturer's line, there are a plethora of options and features to be evaluated and understood by the customer.

Traditionally, the automobile dealership consultants (salespersons) have been tasked with verbally providing this information to the customer. Typically the consultant is expected to commit to memory voluminous amounts of information for multiple makes, models and options regarding each vehicle's features including: component features such as trim level and option packages; maintenance requirements features such as break in period operations; and ownership information features such as warranty, financing and purchase incentives.

In a typical new car purchase inquiry and/or purchase transaction, the customer visits the dealership in search of an automobile meeting the customer's requirements and desires. The customer may not have any information concerning the various features of the vehicles offered by the dealership. The customer may be approached by a consultant wishing to provide assistance to the customer in locating and identifying the make and model meeting the customer's requirements and desires. For the reasons described above, this process can be quite time consuming for both the customer and the consultant, particularly if the customer is unsure about her needs. Additionally, the arrival of customers is not evenly spaced. They may arrive in numbers that exceed the ability of available consultants to provide each customer unlimited time for describing the features of each vehicle that might interest a customer. For a used car dealership, this process may be even more cumbersome. Used cars dealerships have vehicles of various model years made by numerous manufacturers. It follows that both the used vehicle customer and the used vehicle consultant have an even greater number of vehicle features to understand and evaluate. Thus, it would be useful for the consultant to have an inexpensive, easily used device she can provide to the customer that contains a recording of the vehicle information normally provided by the consultant.

Some customers may prefer to use a recorded description of vehicle features to allow them to make their final model selection alone in the absence of any sales pressure from an employee of the dealership or to evaluate the features of a potential selection over an extended period of time. The dealership may benefit from this preference by not having a consultant tied up with a customer who is undecided as to what make, model or vehicle features he desires. The dealership and the customer will benefit from involving the salesperson at a point where the customer knows what he wants.

Once a purchase has been made, the consultant typically verbally reviews the function and operation of the features of the selected vehicle with the customer. Permanent and detailed information is usually provided in the way of an owner's manual, finance documents and warranty documents. For used cars, the detailed documentation, such as an owner's manual, may not be available at the dealership. Occasionally, consultants fail to review the function and operation of all of the features. This quality control issue affects customer satisfaction and requires the dealerships to expend resources to monitor and correct deficiencies. More frequently, the customer fails to retain the information provided by the consultant or may wish to refresh his knowledge of the information without referring to the detailed documentation. Importantly, more customers prefer listening to a description of the function and operation of the feature than prefer reading detailed literature describing the same.

Automobile manufactures and dealers desire to be able to provide to the purchaser of a vehicle permanent audio recordings of vehicle information pertaining to the function and operation of those vehicle features which are of most interest or importance to the customer in a format that the customer favors, is familiar with and will tend to actually use. Since most vehicles have some form of audio media player as an option, it is desirable to provide vehicle information on an audio media device compatible with the particular audio media player installed in the customer's vehicle. Additionally, such an audio media device would be useful in providing training information to consultants for their use in learning the various function and operations of vehicle features for various types of vehicles.

To address this long felt need, this invention discloses a method of providing customers customized vehicle information pertaining to the function and operation of selected vehicle features of a selected vehicle. One preferred method is to provide vehicle information as audio tracts recorded on a compact disc (CD) or cassette. The effort and time required for a consultant to provide a CD or cassette to a customer is very low. Additionally, the compact disc or cassette is a convenient, familiar format by which the customer can access desired vehicle information without having to delve into the detailed information of vehicle owner's manual.

The selected vehicle information describing the function and operation of the features of a selected vehicle can be condensed and enhanced as most needed by a typical customer. The customer is much more likely to use a training device that is easy to use and convenient. The increased likelihood of use increases the safety of the vehicle operations and reduces the customer's complaints and concerns. Also standardizing the delivery and explanation of the vehicle's operations insures that the same high quality level of information is provided to all customers for all vehicles for which this device is used. The compact disc can also be used in an integrated training package. When used with the driver's manual, selectable information stored in a compact disc can refer the customer to a particular page, or portions of the driver's manual for additional, detailed information regarding the function and operations of vehicle features, including such features as trouble shooting or contact information.

From the dealership's point of view, this method allows for a rapid and accurate gathering of product information specific to a particular vehicle and allows for providing that selected information to customized to the interest of a particular customer. The method can be used to provide information to a purchaser of the vehicle, or can be used as a marketing tool for a customer still making a decision regarding the purchase. In addition to information regarding the functions and operations of component features of the selected vehicle, information regarding the maintenance requirement features of the vehicle and ownership information features of the vehicle, including such things as promotional financing can be stored on the a compact disc of this method. An additional advantage of this method is the ability to provide the customer information in the native language of the customer. This is particularly useful for non-English speaking customers, or individuals with limited English capacity. It would also be useful for those customers with reading disabilities or visual impairments.

From the automobile maker's point of view, the advantage of this method and apparatus is the opportunity to provide a standardized, global delivery of product information. For the reasons stated above, this would result in an overall improvement in the general customer satisfaction. It would also provide additional tools to market a product line or a line of finance. It would also provide for the standardization of marketing information received by customers.

Thus, there is a need then for a system and a method for providing to a customer easily referenced audio information pertaining to the function and operation of features of selected vehicle.

There is also a need then for a system and a method for providing to a consultant a means to better inform a customer as to the function and operation of features of a selected vehicle while minimizing the effort and time to provide such information.

Finally, there is a need then for a system and a method for ensuring the quality and completeness of information provided to a customer regarding the features and operation of a vehicle inquired of or purchased.

In this description, the term “automobile” will be used to refer to a wide range of vehicles sold at retail by car dealerships to include cars, trucks, vans and sports/utility vehicles. The term “vehicle” as used herein is intended to have the same meaning as the term automobile. The term “user” as used herein is intended to include customers, consultants and any other individual desiring to posses vehicle information pertaining to the function and operation of features of selected vehicles.

### SUMMARY OF THE INVENTION

An efficient method for management of the information pertaining to the function and operation of vehicle features of the selected vehicles is disclosed. Individual digitized audio recording of spoken information pertaining to the function and operation of individual features of the selected grouping of vehicles are made and stored as individual data files in a common vehicle information database. Information pertaining to the identification of a particular vehicle is input as a sorting index for sorting through and selecting out selected individual data files which, together, contain the information pertaining to the function and operation of such selected features as corresponds to the selected vehicle. That information is then recorded onto an audio media storage device as audio tracks and provided to the customer for use with an audio media player.

### BRIEF DESCRIPTION OF THE DRAWINGS

The invention will be described in detail with reference to the following drawings, in which like reference numerals refer to like elements, and wherein:

FIG. 1 is a block diagram showing components of a system used to practice of one preferred method of this invention.

FIG. 2 is a flow chart showing steps of one preferred method of this invention.

### DESCRIPTION OF THE PREFERRED EMBODIMENTS

In order to effectively manage the information pertaining to the function and operations of the features of the plethora of vehicles, including the various makes, models, trim lines, etc, it would be most efficient to provide a centralized gathering of quanta of information that can be indexed, sorted, and then the resulting sort of information recorded on an audio media storage device to be provided for the customer.

Since modern vehicles are manufactured in a modular fashion, there is a significant degree of modularization in the functions and operation of vehicle features. Thus, it would be inefficient to gather the information regarding the function and operation for all the features of a particular vehicle and then record that information in an audio format. It would be particularly inefficient if the process had to be repeated numerous times for various vehicles, none with exactly the same set of vehicle features. Instead, the most efficient format for management of the information is to record the information pertaining to the function and operation of individual features of the selected grouping of vehicles, to maintain that information on a common database, and to provide information pertaining to the identification of a particular vehicle as a sorting index for sorting through and selecting the information pertaining to the function and operation of such selected features as corresponds to the selected vehicle. That information would then be recorded onto an audio media storage device and provided to the customer for use with an audio media player, at the customer's convenience.

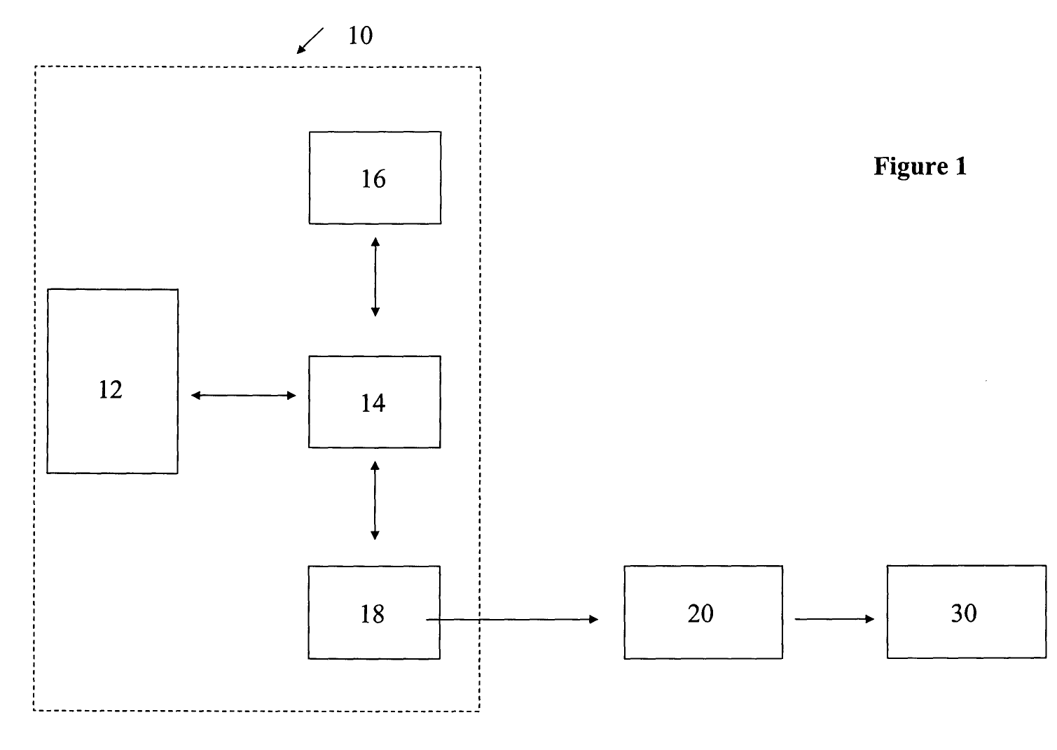

FIG. 1 is a block diagram showing components of a system used to practice of one preferred method of this invention. FIG. 1 shows a computer (10) having a memory (12), adapted for storage of vehicle information in a database. The computer (10) further has a CPU (14) for executing functions including sorting or the database and indexing the database. The computer (10) has an input device (16) for entering the information pertaining to the function and operation of features of selected vehicles and has an output (18) for outputting the sorted information pertaining to the function and operations of the features of a particular selected vehicle, recording that information on an audio media storage device (20) and providing it to the customer for use in playing in an audio media player (30).

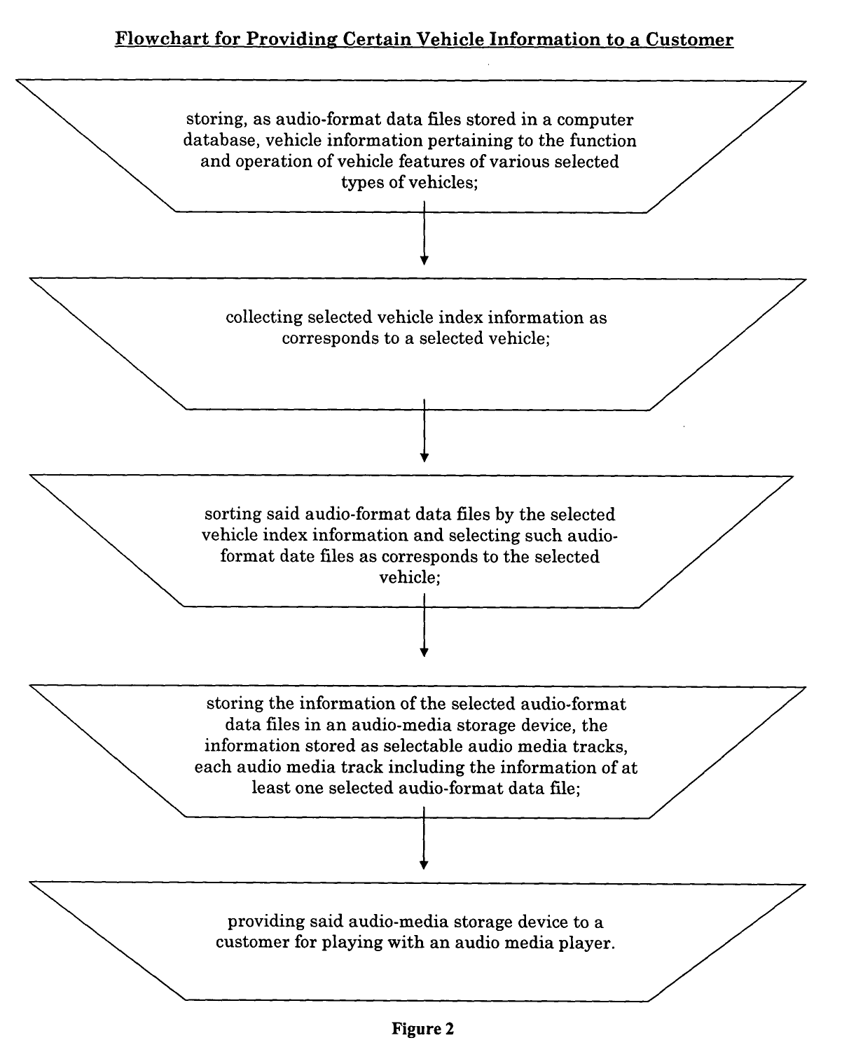

Referring now to FIG. 2, the method of this invention provides for managing vehicle information pertaining to the function and operation of features of selected vehicles so as to provide information pertaining to the function and operation of selected vehicle features of a vehicle to a user. The method includes providing a computer (10) having a vehicle information database for storing vehicle information. The vehicle information is stored in the database in a sortable plurality of audio format data files. The audio format data files are a digitization of a recorded reading of vehicle information pertaining to the function and operation of selected features of selected types of vehicles. Each of the audio format data files includes information pertaining to the function and operation of at least one vehicle feature.

The audio format data files in the database containing the vehicle information are sorted and selected as corresponds to a selected vehicle. The sorted information, in the form of the selected audio format data files, is stored on an audio media device. The audio media device is device adapted to store the information as audio tracks. The selected audio format data files are stored as selectable audio media tracks. Each audio media track contains the information of at least one of the selected audio data files. The audio media storage device is further adapted for operation with an audio player, which is itself adapted to play the audio media tracks. The audio media storage device is then provided to a customer for playing in an audio media player.

In one alternate embodiment of this method, an additional step includes collecting selected vehicle index information corresponding to the selected vehicle. The vehicle index information includes such information as vehicle identification number, vehicle make, vehicle model, model year, model trim level, vehicle option package, individual vehicle options, financing programs, sales programs, and customer identification information. In this alternate method, the audio format data files are sorted by the selected vehicle index information in order to select those audio format data files that correspond to the selected vehicle. The use of vehicle index information in sorting and selecting the audio format data file is necessary in efficiently managing a large vehicle information database storing the audio format data files of numerous makes, models, and options.

The audio format data files stored on the database are digital files, however they may be a digital conversion of analog forms of verbal information. When the audio format data files are sorted, selected and then stored on the audio media storage device, they can be stored as either analog audio tracks or digital audio tracks. The digital audio tracks are formed from audio format media files. Each audio format media file contains the information of at least one of the selected audio format data files.

This method contemplates the use of any of various digital audio formats for the audio format media files and the audio format data files. Exemplar digital audio formats are: MPEG audio layer 3 format (MP3), Windows Media audio format (WMA), OGG format, VQF format, advanced standard audio coating format, WAV audio format (WAV), Digital Video Disc format (DVD), DVD audio format (DVDA), Compact Disc format (CD), Compact Disc Audio format (CDA), Super Audio CD format (SACD), VHS format, and a Real Audio format. Other digital audio formats would be apparent to those skilled in the art and are contemplating buying this invention, as well as the development of follow-on and formatting.

The audio media storage device of the embodiment of the method and apparatus described included a compact disc or variance thereof, such as a digital videodisc. However, the invention also contemplates various embodiments audio media storage device, including: cassettes and computers. Similarly, MP3 players are contemplated audio media storage device, as are the memory cards and other devices in which the audio media files are stored on a memory.

Similarly, the type of audio media player for use with this method is a compact disc player. Other embodiments of this invention employ digital video disc players, MP3 players, computers, and memory cards, as well as cassette players. One skilled in the arts would recognize that the various new developments in audio media storage devices and audio media players can be incorporated into this method and apparatus for practicing the method of this invention.

As stated above the dealership and consultants can employ this method and apparatus to provide vehicle information pertaining to the function and operation of selected vehicle features of a vehicle to a customer. This invention contemplates a wide variety of vehicle features including component features, maintenance requirement features and ownership information features. For example, component features included in the method and apparatus of FIGS. 1 and 2 include information regarding: the ignition systems, the remote entry system, power windows, power locks, power mirrors, trunk release mechanisms, fuel lead release mechanisms, power seats, headlights, turn signals, windshield wiper controls, emergency flashers, odometers, trip meters, speedometers, tachometers, cruise control, emergency brake systems, radio, compact disc players, and cassette players, and other entertainment systems, air conditioner systems, heat and climate control systems, clock displays, multiple information displays, warning lights, electro chromic mirrors, power outlets, external communication systems, cup holders, storage compartment, tires, seatbelts, air bags, safety restraints, and sunshades. These are examples of component features for which information may be stored on the database and sorted for inclusion on the audio media storage device based on the options of the particular vehicle selected. One skilled in the arts will recognize that other such features of vehicles may be included and that future vehicles may have features not yet developed that would obviously fall in the definition of component features.

The method and apparatus of FIGS. 1 and 2 include information regarding the maintenance requirement features of vehicles, including: break in period operations, tire operating pressures, lubrication and hydraulic fluid requirements, heavy use maintenance schedules, preventative maintenance schedules, warning lights, trouble shooting guide, wear component replacement schedules, patent and upholstery cleaning, and repair contact information. These are examples of maintenance requirement features for which information may be stored on the database and sorted for inclusion on the audio media storage device based on the options of the particular vehicle selected. One skilled in the arts will recognize that other such features of vehicles may be included and that future vehicles may have features not yet developed that would obviously fall in the definition of maintenance requirement features.

The method and apparatus of FIGS. 1 and 2 include information regarding ownership information features, including: warranty information, disclaimers, financing information, sales, sales discounts, sales rebates, leasing information, sales contact information, and customer personal information. These are examples of ownership information features for which information may be stored on the database and sorted for inclusion on the audio media storage device based on the options of the particular vehicle selected. One skilled in the arts will recognize that other such features of vehicles may be included and that future vehicles may have features not yet developed that would obviously fall in the definition of ownership information features.

As described above, the method or this invention and devices for practicing the method of this invention are quite varied and flexible. The method and devices for practicing the method are both an information tool for the customer and a time saving tool for the consultant. As well, the method and devices for practicing the method are a training tool for the consultant. They are also a quality control tool for the dealerships, and a marketing tool for the dealerships and manufacturers.

As audio media technology continues to advance, this invention contemplates the substitution of compact disc and compact disc players with more advanced technologies, including yet to be developed audio media storage devices and audio media players. It is anticipated that such technology will merge the definition of audio media storage device and audio media player. This method invention may still be practiced by hereby defining the portion of any audio system to comprise an audio media storage device and audio media player based on the function components of that system provide. For example, an MP3 player or a computer provide an audio media storage device in the form of memory devices within each while also providing software and audio output devices that comprise audio media players.

Thus, although there have been described particular embodiments of the present invention of a new and useful Method and Apparatus for Managing and Providing Vehicle Information, it is not intended that such references be construed as limitations upon the scope of this invention except as set forth in the following claims.

What is claimed is:

1. A method for managing vehicle information pertaining to the function and operation of features of selected vehicles so as to provide information pertaining to the function and operation of selected vehicle features of a vehicle to a user, said method comprising the steps of:
(a) providing a computer having an information database for storing vehicle information;
(b) storing vehicle information in the database, said vehicle information comprising information pertaining to the function and operation of vehicle features of selected types of vehicles, said vehicle information sortably stored as a plurality of audio-format data files, each said audio-format data file comprising information pertaining to the function and operation of at least one vehicle feature;
(c) sorting said audio-format data files and selecting such said audio-format data files as correspond to a selected vehicle;
(d) storing said information of said selected audio-format data files in an audio-media storage device, said audio-media storage device adapted to store audio media tracks, said information of said selected audio-format data files stored as selectable audio media tracks, each said audio media track comprising information of at least one selected audio-format data file, said audio media storage device adapted for operation with an audio media player, said audio media player adapted to play said audio media tracks; and
(e) providing said audio-media storage device to a user for playing with an audio media player.

2. The method of claim 1, said audio-media storage device adapted to store analog audio track, each said audio media track comprising an analog audio track.

3. The method of claim 1, said audio-media storage device adapted to store audio-format media files, each said audio media track comprising an audio-format media file, each said audio-format media file comprising at least one selected audio-format data file.

4. The method of claim 1, said vehicle features comprising features selected from the group including: component features, maintenance requirements features, and ownership information features.

5. The method of claim 4, said component features further comprising features selected from the group including: keys and ignition; remote entry system; power windows; power locks; power mirrors; trunk release mechanism; fuel lid release mechanism; power seats; headlights; turn signals; windshield wiper controls; emergency flashers; odometer; trip meter; speedometer; tachometer; cruise control; emergency brake; radio; compact disk player; cassette player; air conditioning, heating and climate control systems; clock; multiple information display; warning lights; electro-chromic mirror; power outlets; external communication systems; cup holders; storage compartments; tires; seat belts; air bags; safety restraints; and sun shades.

6. The method of claim 4, said maintenance requirements features further comprising features selected from the group including: break in period operations; tire operating pressures; lubrication and hydraulic fluids requirements; heavy use maintenance schedules; preventative maintenance schedules; warning lights; troubleshooting guide; wear component replacement schedules; paint and upholstery cleaning; and repair contact information.

7. The method of claim 4, said ownership information features further comprising features selected from the group including: warranty information, disclaimers, financing information, sales; sales discounts; sales rebates; leasing information; sales contact information; customer personal information.

8. The method of claim 1, said method further comprising the step:
collecting selected vehicle index information as corresponds to said selected vehicle; and
said step of sorting said audio-format data files further comprising sorting said audio-format data files by said selected vehicle index information and selecting such said audio-format data files as corresponds to said selected vehicle further comprising,

9. The method of claim 8, wherein said vehicle index information comprising information selected from the group including: vehicle identification number; vehicle make; vehicle model; model year; model trim level; vehicle option package; vehicle options; financing program, sales programs, owner information.

10. The method of claim 3, wherein, said audio-format data files having a first audio-format and said audio-format media files having a second audio-format, wherein, said first format being incompatible with said second format, said method further comprising the steps of:
reformatting each said selected audio-format data file so as to be compatible with said second format.

11. The method of claim 1, said audio-format data files comprising data files having a format selected from the group including: MPEG audio layer 3 format (MP3), Windows Media audio format (WMA), OGG format, VQF format, advanced standard audio coating format, WAV audio format (WAV), Digital Video Disc format (DVD), DVD audio format (DVDA), Compact Disc format (CD), Compact Disc Audio format (CDA), Super Audio CD format (SACD), VHS format, and a Real Audio format.

12. The method of claim 3, said audio-format media files comprising media files having a format selected from the group including: MPEG audio layer 3 format (MP3), Windows Media audio format (WMA), OGG format, VQF format, advanced standard audio coating format, WAV audio format (WAV), Digital Video Disc format (DVD), DVD audio format (DVDA), Compact Disc format (CD), Compact Disc Audio format (CDA), Super Audio CD format (SACD), VHS format, and a Real Audio format.

13. The method of claim 1, said audio-media storage device comprises a device selected from the group including: cassettes, compact discs, digital video discs; computers; Mp3 players; and memory card devices.

14. The method of claim 1, said audio-media player comprises a device selected from the group including: cassettes, compact discs, digital video discs; computers; Mp3 players; and memory card devices.

15. A method for providing information pertaining to the function and operation of selected vehicle features of a vehicle to a user, said method comprising the steps of:
(a) providing in an audio-media storage device adapted to store audio-media tracks, said audio media storage device adapted for operation with an audio media player, said audio media player adapted to play said audio media tracks;
(b) storing vehicle information in said audio-media storage device, said vehicle information comprising information pertaining to the function and operation of vehicle features of a vehicle, said vehicle information selectably stored as a plurality of audio media tracks, each audio media track comprising information pertaining to the function and operation of at least one vehicle feature; and
(c) providing said audio-media storage device to a user for playing with an audio media player.

16. The method of claim 15, said audio-media storage device adapted to store analog audio tracks, each said audio media track comprising an analog audio track.

17. The method of claim 15, said audio-media storage device adapted to store audio-format media files, each said audio media track comprising an audio-format media file.

18. The method of claim 15, said vehicle features comprising features selected from the group including: component features, maintenance requirements features, and ownership information features.

19. The method of claim 18, said component features comprising features selected from the group including: keys and ignition; remote entry system; power windows; power locks; power mirrors; trunk release mechanism; fuel lid release mechanism; power seats; headlights; turn signals; windshield wiper controls; emergency flashers; odometer; trip meter; speedometer; tachometer; cruise control; emergency brake; radio; compact disk player; cassette player; air conditioning, heating and climate control systems; clock; multiple information display; warning lights; electro-chromic mirror; power outlets; external communication systems; cup holders; storage compartments; tires; seat belts; air bags; safety restraints; and sun shades.

20. The method of claim 18, said maintenance requirements features comprising features selected from the group including: break in period operations; tire operating pressures; lubrication and hydraulic fluids requirements; heavy use maintenance schedules; preventative maintenance schedules; warning lights; troubleshooting guide; wear component replacement schedules; paint and upholstery cleaning; and repair contact information.

21. The method of claim 18, said ownership information features comprising features selected from the group including: warranty information, disclaimers, financing information, sales; sales discounts; sales rebates; leasing information; sales contact information; customer personal information.

22. The method of claim 15, said audio media storage device comprises a device selected from the group including: cassettes, compact discs, digital video discs; computers; Mp3 players; and memory card devices.

23. The method of claim 15, said audio media player comprises a device selected from the group including: cassettes, compact discs, digital video discs; computers; Mp3 players; and memory card devices.

24. The method of claim 17, said audio-format media files comprising media files having a format selected from the group including: MPEG audio layer 3 format (MP3), Windows Media audio format (WMA), OGG format, VQF format, advanced standard audio coating format, WAV audio format (WAV), Digital Video Disc format (DVD), DVD audio format (DVDA), Compact Disc format (CD), Compact Disc Audio format (CDA), Super Audio CD format (SACD), VHS format, and a Real Audio format.

25. A vehicle information storage device, said vehicle information storage device comprising:
an audio-media storage device adapted to store audio media tracks, said audio media storage device further adapted for operation with an audio media player, said audio media player adapted to selectably play said audio media tracks,
a plurality of audio media tracks comprising vehicle information, said vehicle information comprising information pertaining to the function and operation of vehicle features of a vehicle, each audio media track comprising information pertaining to the function and operation of at least one vehicle feature, said plurality of audio media tracks stored on said audio-media storage device.

26. The method of claim 25, said audio-media storage device adapted to store analog audio track, each said audio media track comprising an analog audio track.

27. The method of claim 25, said audio-media storage device adapted to store audio-format media files, each said audio media track comprising an audio-format media file.

28. The apparatus of claim 25, said vehicle features comprising features selected from the group including: component features, maintenance requirements features, and ownership information features.

29. The apparatus of claim 28, said component features comprising features selected from the group including: keys and ignition; remote entry system; power windows; power locks; power mirrors; trunk release mechanism; fuel lid release mechanism; power seats; headlights; turn signals; windshield wiper controls; emergency flashers; odometer; trip meter; speedometer; tachometer; cruise control; emergency brake; radio; compact disk player; cassette player; air conditioning, heating and climate control systems; clock; multiple information display; warning lights; electro-chromic mirror; power outlets; external communication systems; cup holders; storage compartments; tires; seat belts; air bags; safety restraints; and sun shades.

30. The apparatus of claim 28, said maintenance requirements features comprising features selected from the group including: break in period operations; tire operating pressures; lubrication and hydraulic fluids requirements; heavy use maintenance schedules; preventative maintenance schedules; warning lights; troubleshooting guide; wear component replacement schedules; paint and upholstery cleaning; and repair contact information.

31. The apparatus of claim 28, said ownership information features comprising features selected from the group including: warranty information, disclaimers, financing information, sales; sales discounts; sales rebates; leasing information; sales contact information; customer personal information.

32. The apparatus of claim 25, said audio media storage device comprises a device selected from the group including: cassettes, compact discs, digital video discs, computers, Mp3 players, and memory cards.

33. The apparatus of claim 25, said audio media player comprises a device selected from the group including: cassette players, compact disc players, digital video disc players, computers, Mp3 players, and memory cards.

34. The apparatus of claim 25, said audio-format media files comprising media files having a format selected from the group including: MPEG audio layer 3 format (MP3), Windows Media audio format (WMA), OGG format, VQF format, advanced standard audio coating format, WAV audio format (WAV), Digital Video Disc format (DVD), DVD audio format (DVDA), Compact Disc format (CD), Compact Disc Audio format (CDA), Super Audio CD format (SACD), VHS format, and a Real Audio format.
